(19) United States
(12) Patent Application Publication
(10) Pub. No.: US 2008/0273113 A1
(43) Pub. Date: Nov. 6, 2008

(54) Integrated graphics and KVM system

(75) Inventors: Yoel Hayon, Givatayim (IL); Oved Oz, Raanana (IL); Joram Peer, Herzlia (IL); Uri Trichter, Herzlia (IL)

Correspondence Address: ABELMAN, FRAYNE & SCHWAB, 666 THIRD AVENUE, 10TH FLOOR, NEW YORK, NY, 10017, US

(73) Assignee: WINDBOND ELECTRONICS CORPORATION

(21) Appl. No.: 11/800,087

(22) Filed: May 2, 2007

(51) Int. Cl. H04N 11/20

(52) U.S. Cl. 348/446; 348/E11.021

(57) ABSTRACT

Apparatus for display processing includes a host interface, which is arranged to accept graphical information from a first computer. A first display head is arranged to produce a first digital video signal including first frames representing the graphical information at a first frame rate, for displaying the graphical information on a local display of the first computer. A second display head is arranged to produce a second digital video signal including second frames representing the graphical information at a second frame rate that is lower than the first frame rate. A video redirection module is arranged to regulate a transmission rate of the second digital video signal from the second display head, to capture the second frames that are generated by the second display head and to forward the captured frames to a second computer.

### FIELD OF THE INVENTION

The present invention relates generally to remote control of computing platforms, and particularly to methods and systems for efficient capturing and redirection of video frames in remote computer control applications.

### BACKGROUND OF THE INVENTION

Computing platforms commonly use graphics cards or graphics processors for producing graphical information and displaying it on a local display. Several manufacturers offer graphics display devices and modules, which comprise dual display heads for simultaneously driving two displays. For example, Siemens AG (Karlsruhe, Germany) offers a dual-head, 5 Mpixel, gray scale display controller card called SDG 1612D. Aitech Defense Systems, Inc. (Chatsworth, Calif.) offers another dual-head graphics card called M591. Yet another dual-head graphics card is the Radeon® X550 product, produced by ATI-AMD (Santa Clara, Calif.). Some known dual-head graphics processors are specifically intended for server applications, such as the ATI-AMD Radeon 7000, 7000-M and ES10000 devices. Information regarding these devices can be found at www.ati.amd.com/products/server.

Some graphics processors integrate graphics processing functions with remote control and remote management functions, also referred to as Keyboard-Video-Mouse (KVM) functions. For example, the ATI-AMD ES1000 device, cited above, supports Digital Video Output (DVO) ports for remote server management and KVM-over-IP solutions. ASPEED Technology, Inc. (Hsinchu City, Taiwan) produces a remote server management processor called AST-2000. The AST-2000 device incorporates a graphics controller, a Baseboard Management Controller (BMC) and a KVM-over-IP controller in a single chip. Details regarding this device are available at www.aspeedtech.com/ast2000.html.

### SUMMARY OF THE INVENTION

Embodiments of the present invention provide apparatus for display processing, including:

a host interface, which is arranged to accept graphical information from a first computer;

a first display head, which is arranged to produce a first digital video signal including first frames representing the graphical information at a first frame rate, for displaying the graphical information on a local display of the first computer;

a second display head, which is arranged to produce a second digital video signal including second frames representing the graphical information at a second frame rate that is lower than the first frame rate; and

a video redirection module, which is arranged to regulate a transmission rate of the second digital video signal from the second display head, to capture the second frames that are generated by the second display head and to forward the captured frames to a second computer.

In some embodiments, the first display head is arranged to produce the first frames in accordance with a first timing, and the second display head is arranged to produce the second frames in accordance with a second timing that is uncorrelated with the first timing. In another embodiment, the first and second display heads and the video redirection module are integrated in a single Integrated Circuit (IC). In yet another embodiment, the video redirection module is arranged to generate respective requests for producing the second frames, and the second display head is arranged to produce the second frames in response to the requests. In a disclosed embodiment, the second display head and the video redirection module are arranged to exchange flow control commands with one another in order to regulate the transmission rate.

In some embodiments, the second display head and the video redirection module are arranged to regulate the transmission rate by controlling a pixel rate used for transmitting the second video signal. In a disclosed embodiment, the video redirection module is arranged to determine a pixel rate division ratio, and the second display head is arranged to divide the pixel rate by the pixel rate division ratio determined by the video redirection module.

In another embodiment, the second display head and the video redirection module are arranged to access a memory of the first computer for storing and retrieving at least some of the second frames, and to adapt the transmission rate responsively to a memory access bandwidth that is available for accessing the memory. In yet another embodiment, the first and second frames have an identical image resolution and color representation.

In still another embodiment, the apparatus includes one or more memory registers that are accessible to the second display head and to the video redirection module, the second display head is arranged to store configuration parameters used for producing the second frames in the memory registers, and the video redirection module is arranged to retrieve the configuration parameters from the memory registers and to configure the capturing of the second frames using the retrieved parameters.

The configuration parameters may include at least one parameter selected from a group of parameters consisting of a vertical resolution of the second frames, a horizontal resolution of the second frames, a time delay between a horizontal synchronization marker and a next row in the second frames, a time delay between a vertical synchronization marker and the next row in the second frames, a color depth, a pixel frequency, a cursor location, a memory address used for storing the second frames and a status of the second display head.

In some embodiments, the video redirection module is arranged to capture two or more different regions of the graphical information in respective different frames in the second frames, and to reconstruct a captured frame from the multiple different regions.

There is additionally provided, in accordance with an embodiment of the present invention, apparatus for display processing, including:

a host interface, which is arranged to accept graphical information from a first computer;
a first display head, which is arranged to produce first frames of a first digital video signal for displaying the graphical information on a local display of the first computer;

a second display head, which is arranged to produce, in response to requests, respective second frames of a second digital video signal that represents the graphical information; and

a video redirection module, which is arranged to generate the requests for producing the second frames and to capture the requested frames that are generated by the second display head, so as to forward the frames for display on a second computer.

There is also provided, in accordance with an embodiment of the present invention, a method for display processing, including:

accepting graphical information from a first computer;

producing a first digital video signal including first frames representing the graphical information at a first frame rate by a first display head, for displaying the graphical information on a local display of the first computer;

producing a second digital video signal including second frames representing the graphical information at a second frame rate that is lower than the first frame rate by a second display head, while regulating a transmission rate of the second digital video signal from the second display head; and

capturing the second frames generated by the second display head and forwarding the captured frames to a second computer.

In some embodiments, the method includes displaying the graphical information on the second computer using the forwarded second frames. The method may include controlling the first computer by the second computer based on the graphical information displayed on the second computer.

There is further provided, in accordance with an embodiment of the present invention, a method for display processing, including:

accepting graphical information from a first computer;

producing a first digital video signal including first frames representing the graphical information by a first display head, for displaying the graphical information on a local display of the first computer;

generating requests for producing respective second frames of a second digital video signal representing the graphical information;

producing the second digital video signal including the second frames by a second display head; and

capturing the second frames generated by the second display head, so as to forward the captured frames for display on a second computer.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for transferring video from a remote computer, in accordance with an embodiment of the present invention;

FIG. 2 is a block diagram that schematically illustrates an integrated graphics and KVM system, in accordance with an embodiment of the present invention; and

FIG. 3 is a flow chart that schematically illustrates a method for combined local and remote information display, in accordance with an embodiment of the present invention.

### DETAILED DESCRIPTION OF EMBODIMENTS

### Overview

In some computing applications, the graphical information that is produced by a computer is forwarded to another computer, either in addition to or instead of displaying the graphical information locally. These applications are commonly referred to as video redirection applications. Video redirection methods are used, for example, in various remote control and remote access applications, such as for controlling server clusters from a distant controlling computer. In some applications, which are commonly known as Keyboard-Video-Mouse (KVM) applications, the keyboard and mouse input of the controlling computer is transferred to the remote (controlled) computer, in addition to redirecting the video in the opposite direction. KVM applications enable a user to control and operate the remote computer from the controlling computer. The terms “video redirection” and KVM are often used interchangeably to describe both applications that have full remote control functionality using the mouse and keyboard, as well as video-only applications.

KVM applications typically store pixel values of the redirected video frames in one or more memory devices of the controlled computer. The storage and retrieval of these video frames involves large numbers of memory access operations. In many cases, the available memory access bandwidth (i.e., the rate at which the memory devices can be accessed) is a bottleneck of the system, and lack of sufficient memory bandwidth reduces the achievable frame rate and image quality of the redirected video. Thus, it is highly desirable to reduce the memory access bandwidth of the KVM process.

Embodiments of the present invention provide improved methods and systems for capturing and transmitting video of a remote computer to a controlling computer. The methods and systems described herein perform memory access operations at a considerably lower rate in comparison with known methods.

In the embodiments that are described hereinbelow, the remote (controlled) computer comprises an integrated graphics and KVM system, which comprises a graphics subsystem and a KVM subsystem. The graphics subsystem comprises two separate video signal generation units, which are referred to as display heads. The two display heads operate on the same input (i.e., produce video signals that represent the same graphical information) but operate at different rates and have separate, uncorrelated timing.

The first display head generates a real-time, streaming digital video signal that is used for local display. The second display head produces video frames at a considerably lower frame rate in comparison with the first display head, typically on the order of 25%-50%. In some embodiments, the second display head produces video frames on-demand, in response to requests that are generated by the KVM subsystem. The KVM subsystem captures the video frames produced by the second display head and forwards the captured frames to the controlling computer.

The KVM process thus captures and processes a considerably lower number of frames in comparison with known methods, in which the video frames for the KVM process are produced in a real-time, full rate manner. As a result of the reduced frame rate of the KVM process, the rate of memory read and write operations performed by the KVM subsystem, to and from the external memory device, is considerably reduced.

The reduced memory bandwidth requirement can be used to reduce the cost of the external memory and/or memory interface, or to improve the image quality of the redirected video for a given memory bandwidth. Moreover, the reduced frame rate of the redirected video also reduces the communication bandwidth used between the remote computer and the controlling computer.

### System Description

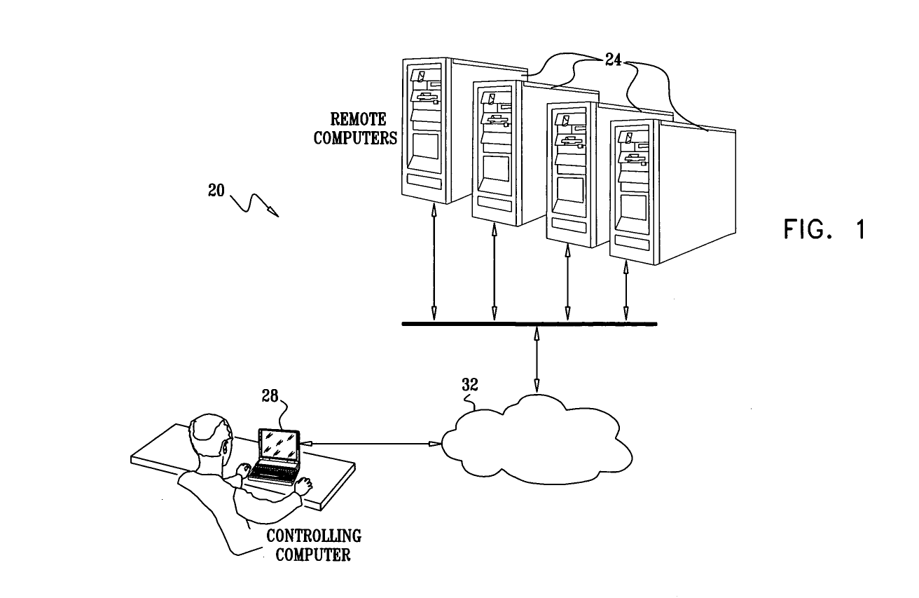

FIG. 1 is a block diagram that schematically illustrates a system 20 for transferring video from remote computers 24, in accordance with an embodiment of the present invention. Each remote computer 24 captures and transmits video frames that represent its screen activity, using methods and devices that are described in detail hereinbelow, to a controlling computer 28 over a communication link 32.

Typically, an operator of system 20 can view the video frames generated by each remote computer 24 on a video display of controlling computer 28. In some embodiments, the capturing and transmission functions of system 20 are part of a remote control system, also referred to as a keyboard-video-mouse (KVM) system, in which the operator remotely controls remote computers 24. In such systems, keyboard and/or mouse signaling is transmitted over communication link 32 to the appropriate remote computer 24. Alternatively, system 20 may be used as a monitoring application that transfers video only. The term KVM is sometimes used to describe all video redirection applications, including video-only applications.

In the exemplary application shown in FIG. 1, remote computers 24 comprise a plurality of servers in a clustered configuration. A system administrator or other operator uses controlling computer 28 to remotely monitor and/or control the operation of the servers. Communication link 32 in this example comprises a local area network (LAN) interconnecting the servers, and a wide-area network (WAN), such as the Internet, over which the controlling computer communicates with the servers.

The configuration shown in FIG. 1 is an exemplary configuration, which is shown purely for the sake of conceptual clarity. In some embodiments, remote computer 24 may comprise a personal computer, a laptop, a workstation, a server, a blade in a multi-processor frame, or any other suitable computing platform that outputs video frames. For simplicity of explanation, the description that follows will refer to a single remote computer 24 and a single controlling computer 28. System 20 may comprise, however, any number of remote computers 24, as well as one or more controlling computers 28. The term “remote computer” means that computer 24 and computer 28 are separate computing platforms, and does not imply any distance relationship between them. Controlling computer 28 may be located either in proximity to or remotely from remote computer 24.

Communication link 32 may comprise any suitable communication connection that connects controlled computer 24 with controlling computer 28, such as an internet protocol (IP) network, a LAN, a WAN, a packet network, a point-to-point or point-to-multipoint connection, a wired or wireless connection, a dial-up or a fixed connection, or a combination of these connection types.

### Integrated Graphics and KVM

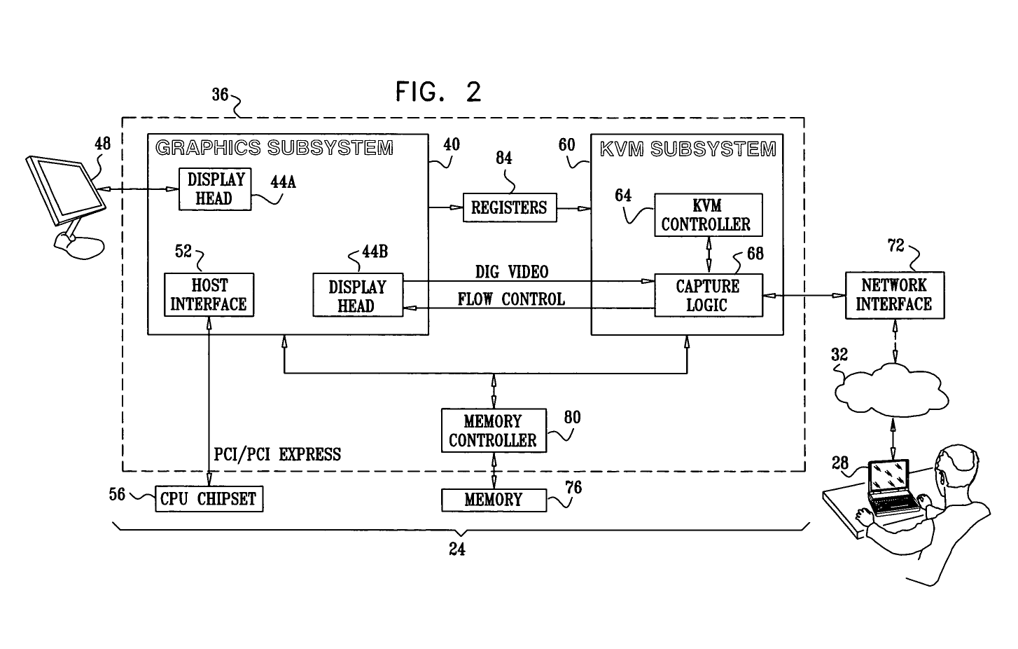

FIG. 2 is a block diagram that schematically illustrates an integrated graphics and KVM system 36, in accordance with an embodiment of the present invention. System 36 accepts information for display from computer 24 and produces two separate digital video signals. One of these signals is used for local video display, and the other signal is transmitted over link 32 to controlling computer 28. System 36 may be implemented using a single Integrated Circuit (IC) or using multiple ICs. The system may reside on a motherboard of computer 24, on a daughterboard or in any other suitable peripheral unit.

System 36 comprises a graphics subsystem 40, which produces the two digital video signals. The graphics subsystem comprises two separate video signal generation units 44A and 44B, which are referred to herein as display heads. Each display head accepts information for display and produces a digital video signal, which can be used for driving a display. In the configuration of FIG. 2, the video signal produced by display head 44A is used for driving a local display 48 of computer 24. The video signal produced by display head 44B is forwarded to controlling computer 28.

Each of the digital video signals typically comprises a sequence of video frames. Each frame comprises a stream of pixel values and synchronization markers, such as vertical synchronization (V-SYNC) and horizontal synchronization (H-SYNC). The sequence of video frames and their internal structure are typically formatted in accordance with a certain digital graphics standard or specification. The video signals produced by the display heads may conform, for example, with known standards such as the Video Graphics Array (VGA), Super VGA (SVGA), extended Graphic Array (XGA), as well as other standards, such as the Video Electronics Standards Association (VESA) display standards. The display heads are typically configured with parameters such as the frame resolution and color depth. The configuration of display heads 44A and 44B is described in greater detail below.

Display heads 44A and 44B operate on the same input, i.e., produce video signals that represent the same graphical information. The two display heads typically produce video in accordance with the same graphics standard and are configured to have the same image parameters, such as resolution and color representation.

Although some of the configuration of display heads 44A and 44B is common, the two display heads of subsystem 40 differ from one another in their frame refresh rate, their timing and their mode of operation. Display head 44A operates in a continuous, streaming, real-time manner and drives local display 48 with a continuous sequence of video frames. The frame refresh rate produced by display head 44A is typically between 25 and 160 Hz, although any other suitable refresh rate can be used.

Display head 44B (whose video is forwarded to controlling computer 28) produces video frames on demand, i.e., in response to external requests. Display head 44B operates at a frame refresh rate, which is determined by the rate of the external requests, and is considerably lower than the frame refresh rate of display head 44B. Typically, the frame refresh rate of display head 44B is on the order of 25%-50% of the frame refresh rate of display head 44A, although other ratios can also be used. Although display heads 44A and 44B operate on the same input, their timing (e.g., frame timing and pixel clock) is generally separate and uncorrelated.

Graphics subsystem 40 comprises a host interface 52, via which the subsystem accepts the information for display. The information is accepted from computer 24, usually from a CPU chipset 56 of the computer. Host interface 52 may be connected to chipset 56 using any suitable connection, such as using the Peripheral Component Interconnect (PCI) or PCI Express interfaces, as are known in the art.

System 36 further comprises a KVM subsystem 60, which captures the digital video produced by display head 44B and forwards the video to controlling computer 28. The KVM subsystem is also referred to as a video redirection module, since in some cases it performs only video redirection and does not handle keyboard or mouse data.

KVM subsystem 60 comprises capture logic 68, which interacts with display head 44B. The capture logic accepts video frames from head 44B over a digital video interface, and exchanges flow control commands with head 44B using a flow control interface. Exemplary implementations of these interfaces are described in greater detail below. KVM subsystem 60 comprises a KVM controller 64, which manages the operation of the KVM subsystem. The KVM subsystem communicates with link 32 using a suitable network interface 72. Although shown as a separate unit, in some embodiments network interface 72 may be integrated within system 36.

In a typical flow, KVM controller 64 determines when a new video frame is to be captured and sent to controlling computer 28. The KVM controller notifies capture logic 68 that a new video frame is requested. The capture logic requests a new frame from display head 44B using the flow control interface. In response to the request, display head 44B produces a video frame and sends it to capture logic 68 over the digital video interface. Capture logic 68 compresses and sends the requested frame via network interface 72 and over link 32, to controlling computer 28.

Both graphics subsystem 40 and KVM subsystem 60 store image data in an external memory 76, which comprises a memory device that is separate from system 36. Graphics subsystem 40 uses external memory 76 to store the pixel values of the video frames produced by display heads 44A and 44B. KVM subsystem 60 uses external memory 76 to store the frames captured by capture logic 68. Typically, subsystems 40 and 60 maintain separate frame buffers in separate areas of memory 76, although in some cases the two subsystems may share a particular frame buffer.

In some embodiments, the KVM subsystem transmits to the controlling computer only pixels or groups of pixels whose values have changed with respect to the previously-transmitted frame. In order to determine which pixel values have changed, the KVM subsystem usually stores a reference video frame, or parts thereof, in memory 76. The reference frame represents the last frame transmitted to the controlling computer.

The access of subsystems 40 and 60 to external memory 76 is controlled by a memory controller 80. Memory controller 80 accesses memory 76 using a suitable memory bus. As noted above, the frame rate of display head 44B and capture logic 68 is considerably lower than the frame rate of display head 44A. In some cases, this frame rate it not constant and is determined by the rate of the requests generated by the KVM subsystem. As a result, the rate of memory access operations performed with memory 76 is minimized, since the memory is accessed by the KVM subsystem less frequently, and in some cases only when a new video frame is actually requested. This feature is in contrast to some known video redirection and KVM methods, in which the redirected video is captured and processed in real time, often at the same frame rate as the locally displayed video.

KVM controller 64 may decide to request new video frames based on any suitable trigger or criterion. For example, new video frames may be requested by controlling computer 28, in accordance with the KVM protocol being used. Additionally or alternatively, a new video frame may be requested when sufficient bandwidth is available for accessing memory 76, and new requests may be avoided when the available memory access bandwidth is not sufficient. As yet another example, the KVM subsystem may request new frames when sufficient communication bandwidth is available on link 32, and refrain from requesting new frames when the link is congested.

In some embodiments, the digital video interface (sometimes referred to as Digital Video Output—DVO) between head 44B and capture logic 68 comprises a pixel clock, horizontal sync (H-SYNC) markers, vertical sync (V-SYNC) markers and digital pixel values. Typically, each pixel is represented using Red, Green and Blue (RGB) pixel values. For example, each pixel can be represented using fifteen bits, with five bits representing each of the colors. Alternatively, any other suitable format can also be used.

In some embodiments, the flow control interface between display head 44B and capture logic 68 comprises several discrete Input/Output (I/O) signals. The interface enables display head 44B and capture logic 68 to regulate the rate at which video is transmitted from the display head to the capture logic. Regulating the transmission rate may comprise controlling the rate at which display head 44B produces frames and/or the rate at which pixels are transmitted over the digital video interface.

In an exemplary implementation, the interface comprises a frame request (FREQ) signal, a digital video wait (DVW) signal and a digital video valid (DVV) signal. The FREQ signal is set by the capture logic to indicate to head 44B that a new video frame is requested. When the requested frame is sent by the display head, the FREQ signal is reset before the frame ends. The DVW signal is a backpressure signal, which is set by the capture logic when the capture logic is unable to accept additional video data in order to prevent overflow. In some cases, a limited number of pixel values, such as 128 pixel values, may be allowed after the DVW signal is set.

The DVV signal, which is set and reset by display head 44B, qualifies every clock cycle of the digital video. When the DVV signal is set during the rising edge of a particular clock cycle, this clock cycle is assumed valid by the capture logic. The data and synchronization of this clock cycle are accepted and the appropriate pixel counters are advanced. When the DVV signal is reset during the rising edge of a particular clock cycle, the clock cycle is ignored. The DVV signal can be reset, for example, in response to a setting of the DVW by the capture logic. The DVV signal can also be reset by display head 44B as a means for reducing the pixel rate on the digital video interface. For example, when the available bandwidth for accessing external memory 76 is not sufficient, display head 44B can reduce the pixel rate by setting the DVV signal.

In some embodiments, the configuration of the video frames provided by graphics subsystem 40 to KVM subsystem 60 is coordinated between the two subsystems using mirrored registers 84, which can be accessed by both subsystems. Graphics subsystem 40 writes configuration parameters into registers 84, and subsystem 60 reads the parameter values and adapts its operation accordingly. By using the mirrored register mechanism, the KVM subsystem can be configured a-priori, and does not need to deduce the configuration parameters (e.g., image resolution) from the accepted video frames.

The configuration parameters that are coordinated using registers 84 may comprise, for example, the vertical and horizontal resolution of the frame (i.e., the number of pixels in each dimension), the time delay between the H-SYNC marker and the first pixel in the next row, the time delay between the V-SYNC marker and the first row in the frame, the color depth used (e.g., the number of bits used for representing each pixel color value) and the currently-used pixel frequency (e.g., the frequency in which pixel values are sent). The pixel frequency and color depth values define the memory bandwidth used by display head 44A. The configuration parameters may also comprise additional data, such as the current screen location of the cursor, the address of the frame buffer in the external memory, the current status of display head 44B (e.g., V-SYNC, reset, clock disabled), and/or any other suitable data item.

The flow control interface may also comprise discrete lines or mirrored register bits that indicate a division ratio of the pixel clock produced by display head 44B. The clock division ratio can be changed by the KVM controller to increase and decrease the pixel rate of the video signal provided by display head 44B, for example when the available memory access bandwidth or communication bandwidth is not sufficient.

In some embodiments, the capture logic can spread the capturing of a single frame buffer from display head 44B over several frames (i.e., over several frame intervals of display head 44A). This coordination enables the capture logic to distribute the memory access operations over a longer time period, thus reducing the peak bandwidth demand. In some embodiments, the display area is divided into multiple different regions. When capturing the frames produced by display head 44B, the capture logic captures each region from a different frame. For example, the captured screen image can be divided into N (e.g., five) vertical strips. In the present example, capture logic 68 fills a single frame buffer during N frame intervals. In each frame interval, only the pixel values of a particular vertical strip are captured and written to memory 76. Using this technique, the peak memory bandwidth demand is reduced by a factor of N. Alternatively, the screen image, i.e., the graphical information, can be divided into regions having any other suitable shape or size.

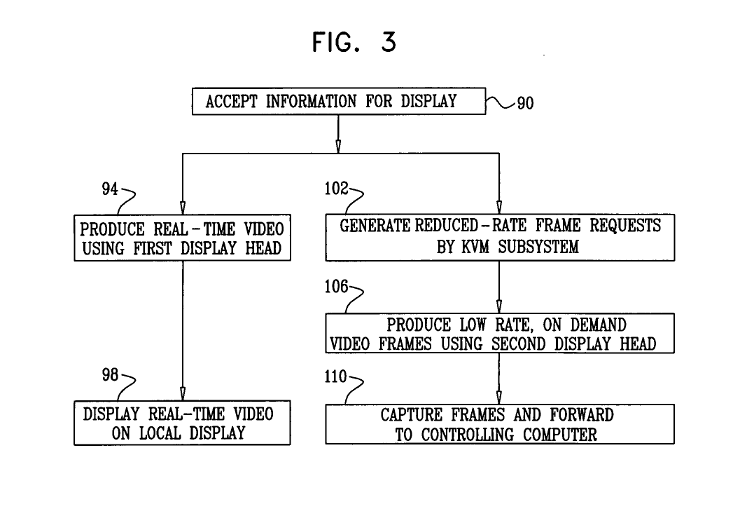

FIG. 3 is a flow chart that schematically illustrates a method for combined local and remote information display, in accordance with an embodiment of the present invention. The method begins with host interface 52 of system 36 accepting information for display from computer 24, at an input step 90.

Display head 44A produces a continuous, real-time digital video signal based on the input information, at a first signal generation step 94. The real-time video signal is displayed on local display 48, at a local display step 98.

In parallel to producing and displaying the real-time video signal by the graphics subsystem, the KVM subsystem generates requests for producing on-demand video frames, at a request generation step 102. As noted above, the rate and timing of the requests may depend on factors such as the available memory access bandwidth toward external memory 76, the available communication bandwidth over link 32 and the particular KVM communication protocol used.

In response to the requests generated by the KVM subsystem, display head 44B produces video frames, at a second signal generation step 106. The video frames produced by display head 44B are produced on-demand, and typically have a considerably lower frame rate in comparison with the frame rate of head 44A.

Capture logic 68 captures the frames produced by head 44B, and the KVM subsystem forwards the captured frames to controlling computer 28, at a forwarding step 110. The controlling computer uses the forwarded frames to reconstruct and display the screen activity of computer 24.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. Apparatus for display processing, comprising:
a host interface, which is arranged to accept graphical information from a first computer;
a first display head, which is arranged to produce a first digital video signal comprising first frames representing the graphical information at a first frame rate, for displaying the graphical information on a local display of the first computer;
a second display head, which is arranged to produce a second digital video signal comprising second frames representing the graphical information at a second frame rate that is lower than the first frame rate; and
a video redirection module, which is arranged to regulate a transmission rate of the second digital video signal from the second display head, to capture the second frames that are generated by the second display head and to forward the captured frames to a second computer.

2. The apparatus according to claim 1, wherein the first display head is arranged to produce the first frames in accordance with a first timing, and wherein the second display head is arranged to produce the second frames in accordance with a second timing that is uncorrelated with the first timing.

3. The apparatus according to claim 1, wherein the first and second display heads and the video redirection module are integrated in a single Integrated Circuit (IC).

4. The apparatus according to claim 1, wherein the video redirection module is arranged to generate respective requests for producing the second frames, and wherein the second display head is arranged to produce the second frames in response to the requests.

5. The apparatus according to claim 1, wherein the second display head and the video redirection module are arranged to exchange flow control commands with one another in order to regulate the transmission rate.

6. The apparatus according to claim 1, wherein the second display head and the video redirection module are arranged to regulate the transmission rate by controlling a pixel rate used for transmitting the second video signal.

7. The apparatus according to claim 6, wherein the video redirection module is arranged to determine a pixel rate division ratio, and wherein the second display head is arranged to divide the pixel rate by the pixel rate division ratio determined by the video redirection module.

8. The apparatus according to claim 1, wherein the second display head and the video redirection module are arranged to access a memory of the first computer for storing and retrieving at least some of the second frames, and to adapt the transmission rate responsively to a memory access bandwidth that is available for accessing the memory.

9. The apparatus according to claim 1, wherein the first and second frames have an identical image resolution and color representation.

10. The apparatus according to claim 1, and comprising one or more memory registers that are accessible to the second display head and to the video redirection module, wherein the second display head is arranged to store configuration parameters used for producing the second frames in the memory registers, and wherein the video redirection module is arranged to retrieve the configuration parameters from the memory registers and to configure the capturing of the second frames using the retrieved parameters.

11. The apparatus according to claim 10, wherein the configuration parameters comprise at least one parameter selected from a group of parameters consisting of a vertical resolution of the second frames, a horizontal resolution of the second frames, a time delay between a horizontal synchronization marker and a next row in the second frames, a time delay between a vertical synchronization marker and the next row in the second frames, a color depth, a pixel frequency, a cursor location, a memory address used for storing the second frames and a status of the second display head.

12. The apparatus according to claim 1, wherein the video redirection module is arranged to capture two or more different regions of the graphical information in respective different frames in the second frames, and to reconstruct a captured frame from the multiple different regions.

13. Apparatus for display processing, comprising:
a host interface, which is arranged to accept graphical information from a first computer;
a first display head, which is arranged to produce first frames of a first digital video signal for displaying the graphical information on a local display of the first computer;
a second display head, which is arranged to produce, in response to requests, respective second frames of a second digital video signal that represents the graphical information; and
a video redirection module, which is arranged to generate the requests for producing the second frames and to capture the requested frames that are generated by the second display head, so as to forward the frames for display on a second computer.

14. A method for display processing, comprising:
accepting graphical information from a first computer;
producing a first digital video signal comprising first frames representing the graphical information at a first frame rate by a first display head, for displaying the graphical information on a local display of the first computer;
producing a second digital video signal comprising second frames representing the graphical information at a second frame rate that is lower than the first frame rate by a second display head, while regulating a transmission rate of the second digital video signal from the second display head; and
capturing the second frames generated by the second display head and forwarding the captured frames to a second computer.

15. The method according to claim 14, and comprising displaying the graphical information on the second computer using the forwarded second frames.

16. The method according to claim 15, and comprising controlling the first computer by the second computer based on the graphical information displayed on the second computer.

17. The method according to claim 14, wherein producing the first digital video signal comprises producing the first frames in accordance with a first timing, and
wherein producing the second digital video signal comprises producing the second frames in accordance with a second timing that is uncorrelated with the first timing.

18. The method according to claim 14, wherein regulating the transmission rate comprises generating respective requests for producing the second frames, and producing the second frames by the second display head in response to the requests.

19. The method according to claim 14, wherein regulating the transmission rate comprises exchanging flow control commands with the second display head.

20. The method according to claim 14, wherein regulating the transmission rate comprises controlling a pixel rate used for transmitting the second video signal by the second display head.

21. The method according to claim 20, wherein controlling the pixel rate comprises setting a pixel rate division ratio, and dividing the pixel rate by the pixel rate division ratio.

22. The method according to claim 14, wherein producing the second digital video signal and capturing the second frames comprise accessing a memory of the first computer for storing and retrieving at least some of the second frames, and wherein regulating the transmission rate comprises adapting the transmission rate responsively to a memory access bandwidth that is available for accessing the memory.

23. The method according to claim 14, wherein the first and second frames have an identical image resolution and color representation.

24. The method according to claim 14, wherein producing the second digital video signal comprises storing configuration parameters used for producing the second frames in memory registers, and wherein capturing the second frames comprises retrieving the configuration parameters from the memory registers and configuring the capturing of the second frames using the retrieved parameters.

25. The method according to claim 24, wherein the configuration parameters comprise at least one parameter selected from a group of parameters consisting of a vertical resolution of the second frames, a horizontal resolution of the second frames, a time delay between a horizontal synchronization marker and a next row in the second frames, a time delay between a vertical synchronization marker and the next row in the second frames, a color depth, a pixel frequency, a cursor location, a memory address used for storing the second frames and a status of the second display head.

26. The method according to claim 14, wherein capturing the second frames comprises capturing two or more different regions of the graphical information in respective different frames in the second frames, and reconstructing a captured frame from the multiple different regions.

27. A method for display processing, comprising:
accepting graphical information from a first computer;
producing a first digital video signal comprising first frames representing the graphical information by a first display head, for displaying the graphical information on a local display of the first computer;
generating requests for producing respective second frames of a second digital video signal representing the graphical information;
producing the second digital video signal comprising the second frames by a second display head; and
capturing the second frames generated by the second display head, so as to forward the captured frames for display on a second computer.
